(19) United States
(12) Patent Application Publication
(10) Pub. No.: US 2015/0296383 A1
(43) Pub. Date: Oct. 15, 2015

(54) WIRELESS COMMUNICATIONS APPARATUS AND METHOD

(71) Applicant: SAMSUNG ELECTRO-MECHANICS CO., LTD., Suwon-Si (KR)

(72) Inventors: Byong Hyok CHOI, Suwon-Si (KR); Jeong Su SEO, Suwon-Si (KR)

(21) Appl. No.: 14/582,802

(22) Filed: Dec. 24, 2014

(30) Foreign Application Priority Data
Apr. 10, 2014 (KR) 10-2014-0043143

(51) Int. Cl. H04W 16/14; H04W 24/02

(52) U.S. Cl. CPC H04W 16/14; H04W 24/02

(57) ABSTRACT

A wireless communications apparatus may include: a channel monitoring unit monitoring a state of a communications channel according to a first communications standard and providing channel state information; a controlling unit deciding whether or not channel interference is present based on the channel state information; and an interference removing signal generating unit transmitting an interference removing signal to at least one of a plurality of channels adjacent to the communications channel when channel interference is present. Therefore, interference between heterogeneous communications networks may be decreased, such that wireless communications may be more stably performed.

### CROSS-REFERENCE TO RELATED APPLICATION

This application claims the benefit of Korean Patent Application No. 10-2014-0043143 filed on Apr. 10, 2014, with the Korean Intellectual Property Office, the disclosure of which is incorporated herein by reference.

### BACKGROUND

The present disclosure relates to a wireless communications apparatus and method.

Generally, a repeater (for example, a gateway) provided in an electronic shelf label (ESL) system may perform wireless communications in order to transmit to a plurality of electronic price tags, product information, and the like.

For example, the repeater may perform wireless communications, according to the IEEE 802.15.4 communications standard, with the electronic tags. In this case, the repeater may use some of a plurality of channels within the 5 MHz bandwidth at the 2.4 GHz frequency, defined in the IEEE 802.15.4 communications standard.

Meanwhile, the 2.4 GHz frequency is also used in the IEEE 802.11 communications standard employed in a wireless local area network (WLAN) communications standard such as WiFi, or the like. When an ESL system and a WLAN communications system using different communications standards exist in an interference region, the 2.4 GHz frequency of the IEEE 802.15.4 communications standard used in the ESL system may be overlapped with the 2.4 GHz frequency of the IEEE 802.11 communications standard used in the WLAN communications system.

Here, since a transmission signal power in the IEEE 802.11 communications standard is several times stronger than a transmission signal power in the IEEE 802.15.4 communications standard, severe interference may be caused between the heterogeneous communications networks employing the two above-mentioned communications standards.

Therefore, an ESL system according to the related art should use a channel that is not overlapped with a channel according to the IEEE 802.11 communications standard in order to avoid interference with the channel according to the IEEE 802.11 communications standard. However, as an example, in the case where the channel that is not overlapped with the channel according to the IEEE 802.11 communications standard is not present, a communications delay or a communications default may be caused.

In addition, in the case that an access point (AP) of the WiFi according to the IEEE 802.11 communications standard suddenly uses the same channel as used by the repeater of the ESL system during a period in which the repeater of the ESL system is used, a large amount of interference may be caused in the communications of the ESL system.

Therefore, the ESL system according to the related art has a technical object that an interference with the channel according to the IEEE 802.11 communications standard should be excluded.

The following Related Art Document (Patent Document 1) relates to a wireless communications apparatus, but does not disclose a solution for the above-mentioned technical object.

### RELATED ART DOCUMENT

(Patent Document 1) Japanese Patent Laid-Open Publication No. 2010-178228

### SUMMARY

An exemplary embodiment in the present disclosure may provide a wireless communications apparatus and method capable of decreasing interference between heterogeneous communications networks.

According to an exemplary embodiment in the present disclosure, a wireless communications apparatus may include: a channel monitoring unit monitoring a state of a communications channel according to a first communications standard and providing channel state information; a controlling unit deciding whether or not channel interference is present based on the channel state information; and an interference removing signal generating unit transmitting an interference removing signal to at least one of a plurality of channels adjacent to the communications channel when channel interference is present.

With the wireless communications apparatus, interference between heterogeneous communications networks maybe decreased, such that wireless communications may be more stably performed.

### BRIEF DESCRIPTION OF DRAWINGS

The above and other exemplary embodiments, features and other advantages in the present disclosure will be more clearly understood from the following detailed description taken in conjunction with the accompanying drawings, in which:

FIG. 1 is a block diagram illustrating a configuration of an electronic shelf label system to which an exemplary embodiment in the present disclosure may be applied;

FIG. 2 is a block diagram of a wireless communications apparatus according to an exemplary embodiment in the present disclosure;

FIG. 3 is a block diagram of a wireless communications apparatus according to another exemplary embodiment in the present disclosure;

FIG. 4 is a flow chart of a wireless communications method according to an exemplary embodiment in the present disclosure;

FIG. 5 is a flow chart of a wireless communications method according to another exemplary embodiment in the present disclosure;

FIG. 6 is a flow chart illustrating an operation of deciding whether or not channel interference is present according to an exemplary embodiment in the present disclosure;

FIG. 7 is a flow chart of a wireless communications method according to another exemplary embodiment in the present disclosure;

FIG. 8 is a flow chart illustrating a process of deciding whether or not channel transmission data are present according to an exemplary embodiment in the present disclosure;

FIG. 9 is a view for describing an example of generation of an interference removing signal according to an exemplary embodiment in the present disclosure;

FIG. 10 is a view illustrating an example of a generation band of an interference removing signal according to an exemplary embodiment in the present disclosure;

FIG. 11 is a view illustrating another example of a generation band of an interference removing signal according to an exemplary embodiment in the present disclosure;

FIG. 12 is a view illustrating another example of a generation band of an interference removing signal according to an exemplary embodiment in the present disclosure;

FIG. 13 is a view illustrating another example of a generation band of an interference removing signal according to an exemplary embodiment in the present disclosure; and

FIG. 14 is a view illustrating another example of a generation band of an interference removing signal according to an exemplary embodiment in the present disclosure.

### DETAILED DESCRIPTION

Hereinafter, embodiments in the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

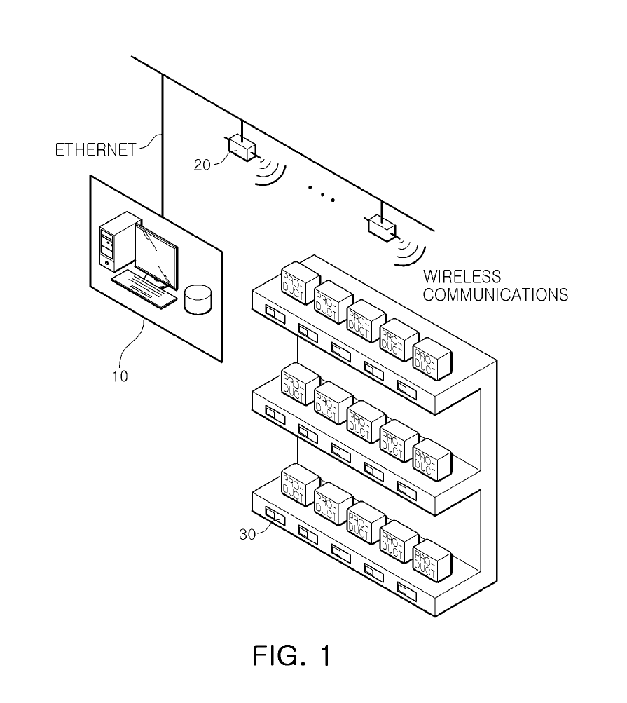

FIG. 1 is a block diagram illustrating a configuration of an electronic shelf label system to which an exemplary embodiment in the present disclosure may be applied. Referring to FIG. 1, the electronic shelf label system to which an exemplary embodiment in the present disclosure may be applied may include a server 10, relay apparatuses 20, and electronic tags 30.

The server 10 may provide product information to the relay apparatuses 20 through a wired communications network (for example, Ethernet). The replay apparatuses 20 may provide the product information to the electronic tags 30 through a wireless communications network (for example, wireless personal area network (WPAN) communications).

For example, a wireless communications apparatus according to an exemplary embodiment in the present disclosure may be applied to the replay apparatuses of the electronic shelf label system. Therefore, hereinafter, the case in which the wireless communications apparatus according to an exemplary embodiment in the present disclosure may be used as repeaters of the electronic shelf label system will be described below by way of example. In this case, the IEEE 802.15.4 communications standard may be used in the electronic shelf label system, and the IEEE 802.11 communications standard may be used in a wireless local area network (WLAN) communications network (for example, a WiFi communications network) causing channel interference with a communications network of the electronic shelf label system. Hereinafter, technical contents for eliminating channel interference between heterogeneous communications networks described above will be described.

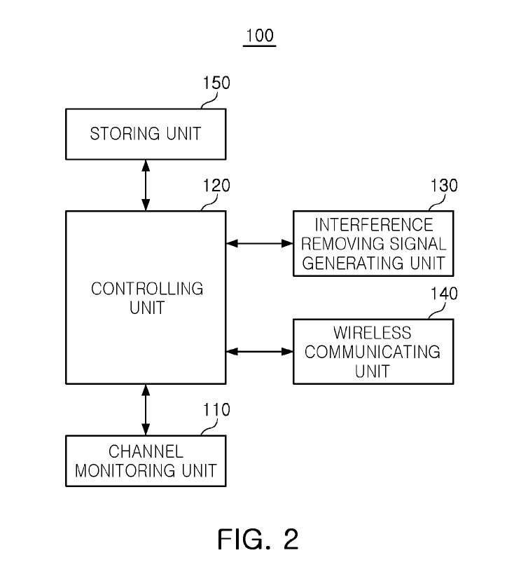

FIG. 2 is a block diagram of a wireless communications apparatus according to an exemplary embodiment in the present disclosure.

Referring to FIG. 2, the wireless communications apparatus according to an exemplary embodiment in the present disclosure may include a channel monitoring unit 110, a controlling unit 120, and an interference removing signal generating unit 130.

The wireless communications apparatus may further include a wireless communicating unit 140 and a storing unit 150.

The channel monitoring unit 110 may monitor a state of a communications channel according to a first communications standard and provide channel state information.

For example, when it is assumed that the first communications standard is the IEEE 802.15.4 communications standard, the channel monitoring unit 110 may receive a signal through a communications channel of the IEEE 802.15.4 communications standard, measure a received signal strength indication (RSSI), and provide the channel state information including the received signal strength indication to the controlling unit 120.

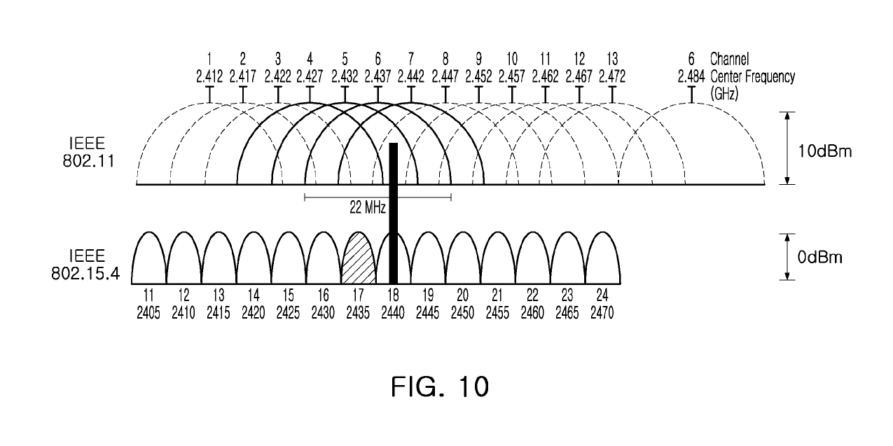

In addition, the channel monitoring unit 110 may monitor states for a plurality of channels adjacent to the communications channel in addition to the communications channel, and provide channel state information on the adjacent channels together with the channel state information on the communications channel. Here, the adjacent channel, a channel using a frequency band close to that of the communications channel, may be a channel causing interference with the communications channel. As an example, in the case in which the communications channel is a channel No. 17 (2435 MHz) of the IEEE 802.15.4 communications standard, the adjacent channel may be one of a channel No. 15 (2425 MHz), a channel No. 16 (2430 MHz), a channel No. 18 (2440 MHz), and a channel No. 19 (2445 MHz) (See FIGS. 10 through 14).

The controlling unit 120 may decide whether or not channel interference is present based on the channel state information.

For example, the controlling unit 120 may compare the received signal strength indication included in the channel state information with reference strength, and decide that channel interference is present in the case in which the received signal strength indication is higher than the reference strength and decide that channel interference is not present in the case in which the received signal strength indication is not higher than the reference strength.

Here, the reference strength may be, for example, a reference voltage preset in order to decide whether or not channel interference is present.

The interference removing signal generating unit 130 may transmit an interference removing signal to at least one of the plurality of channels adjacent to the communications channel when channel interference is present as a decision result of the controlling unit 120.

Alternatively, the interference removing signal generating unit 130 may simultaneously transmit the interference removing signal to the plurality of adjacent channels in order to further improve an interference removing effect as compared with a method of transmitting the interference removing signal to one adjacent channel. As an example, the interference removing signal generating unit 130 may transmit the interference removing signal to at least one lower channel and at least one upper channel of the plurality of channels adjacent to the communications channel.

Here, the interference removing signal may be a signal that includes information or a signal that does not include the information, but has signal strength for simple implementation. In addition, the interference removing signal may have signal strength that becomes channel interference in a communications network according to a second communications standard causing interference in the communications channel. For example, when it is assumed that the second communications standard is the IEEE 802.11 (for example, 11a, 11b, 11n, 11ac, or the like) communications standard, the interference removing signal may have signal strength of approximately 10 dBm that may become channel interference in the IEEE 802.11 communications standard. This description may be applied to each of exemplary embodiments in the present disclosure.

The adjacent channel to which the above-mentioned interference removing signal is transmitted will be described below with reference to FIGS. 10 through 14.

The wireless communicating unit 140 may wirelessly transmit transmission data without monitoring channel interference after the interference removing signal is transmitted, as an example.

Alternatively, the wireless communicating unit 140 may monitor channel interference and wirelessly transmit the transmission data when channel interference disappears, as another example.

Meanwhile, when the wireless communications apparatus (for example, a WPAN communications apparatus) according to an exemplary embodiment in the present disclosure transmits the interference removing signal to at least one of the plurality of adjacent channels of the communications channel according to the first communications standard (for example, the IEEE 802.15.4 communications standard), a communications system (for example, a WiFi communications system) of the second communications standard (for example, the IEEE 802.11 communications standard) may not use the corresponding channel in order to avoid interference in the case in which the signal strength becoming channel interference is present while monitoring each of the plurality of channels.

In addition, the storing unit 150 may store the transmission data therein. For example, in the case in which the wireless communications apparatus is used as the repeater of the electronic shelf label system, the transmission data may include identification information of the repeater and the electronic tag to be transmitted to the electronic tag and product information such as a product name, a product price, a manufactured date, and the like.

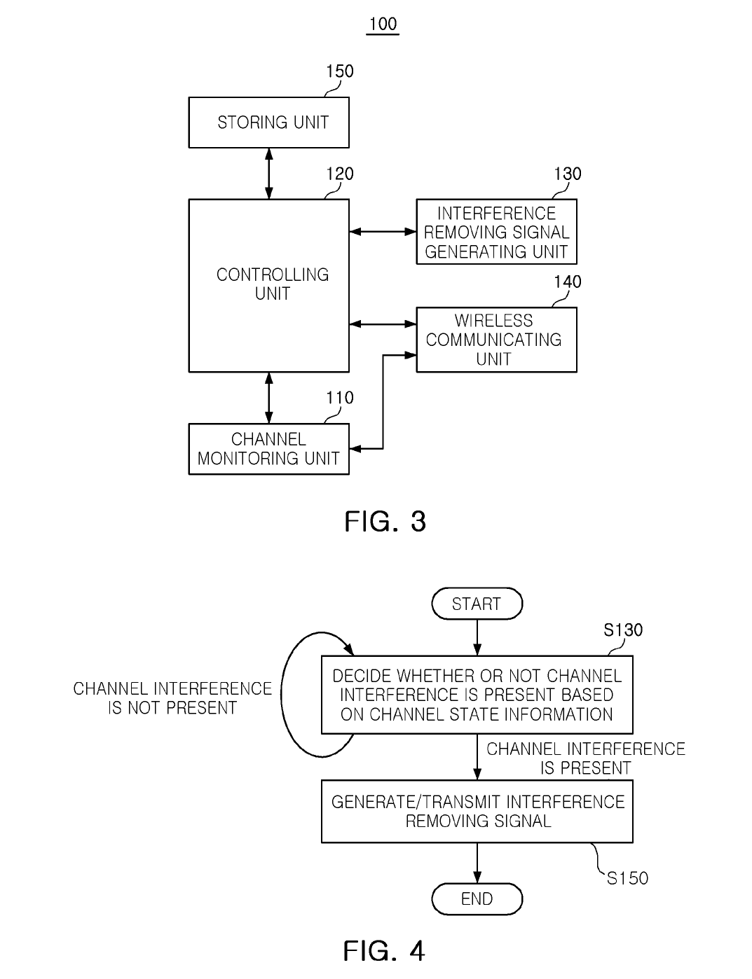

As described above, contents described with reference to FIG. 2 may be applied to another exemplary embodiment and another implementation in the present disclosure shown in FIGS. 3 through 9. In the case in which the contents described with reference to FIG. 2 are not specially described in another exemplary embodiment and another implementation in the present disclosure, in order to avoid overlapped descriptions, a description for the contents will be replaced by the above-mentioned description.

FIG. 3 is a block diagram of a wireless communications apparatus according to another exemplary embodiment in the present disclosure.

Referring to FIG. 3, the wireless communications apparatus according to an exemplary embodiment in the present disclosure may include a channel monitoring unit 110, a controlling unit 120, an interference removing signal generating unit 130, and a wireless communicating unit 140. In addition, the wireless communications apparatus according to an exemplary embodiment in the present disclosure may further include a storing unit 150.

A description for the same operations as the operations described with reference to FIG. 2 among operations of the channel monitoring unit 110, the controlling unit 120, the interference removing signal generating unit 130, and the wireless communicating unit 140 shown in FIG. 3 will be omitted in order to avoid an overlapped description.

Referring to FIG. 3, the controlling unit 120 may decide whether or not channel interference is present based on the channel state information at the time of generation of the transmission data and control generation of the interference removing signal when channel interference is present.

The interference removing signal generating unit 130 may generate the interference removing signal depending on a control of the controlling unit 120 and transmit the interference removing signal at least once to at least one of the plurality of channels adjacent to the communications channel.

For example, the interference removing signal may be transmitted at least once or be repeatedly transmitted several times. Even in the case in which the interference removing signal is transmitted only once, interference may be caused in the communications network according to the second communications standard to restrain communications. However, the interference removing signal may be repeatedly transmitted several times in order to more securely cause interference.

The channel monitoring unit 110 may be implemented so as to include a transmitting and receiving function as shown in FIG. 2, as an example. In this case, the channel monitoring unit 110 may perform monitoring of the channel using the transmitting and receiving function.

Unlike this, the channel monitoring unit 110 does not include the transmitting and receiving function, but may perform monitoring of the communications channel using a transmitting and receiving function of the wireless communicating unit 140, as shown in FIG. 3. In this case, the channel monitoring unit 110 may receive a signal of the communications channel through the wireless communicating unit 140 in order to monitor a state of the communications channel.

The controlling unit 120 may wait when channel interference is present during a period in which the interference removing signal is repeatedly transmitted and control transmission of the transmission data when channel interference disappears, as an example.

The interference removing signal generating unit 130 may transmit the interference removing signal to at least one of the plurality of channels adjacent to the communications channel when channel interference is present as the decision result of the controlling unit 120, as described above. Alternatively, the interference removing signal generating unit 130 may transmit the interference removing signal to at least one lower channel and at least one upper channel of the plurality of channels adjacent to the communications channel.

Meanwhile, the interference removing signal generating unit 130 may determine an adjacent channel to which the interference removing signal is to be transmitted depending on channel states for the adjacent channel monitored by the channel monitoring unit 110. For example, in the case in which the communications channel is the channel No. 17 (2435 MHz) of the IEEE 802.15.4 communications standard, the interference removing signal generating unit 130 may select one or more of the channel No. 15 (2425 MHz), the channel No. 16 (2430 MHz), the channel No. 18 (2440 MHz), and the channel No. 19 (2445 MHz), which are the channels adjacent to the communications channel, based on the most severe interference, and transmit the interference removing signal to the selected adjacent channel.

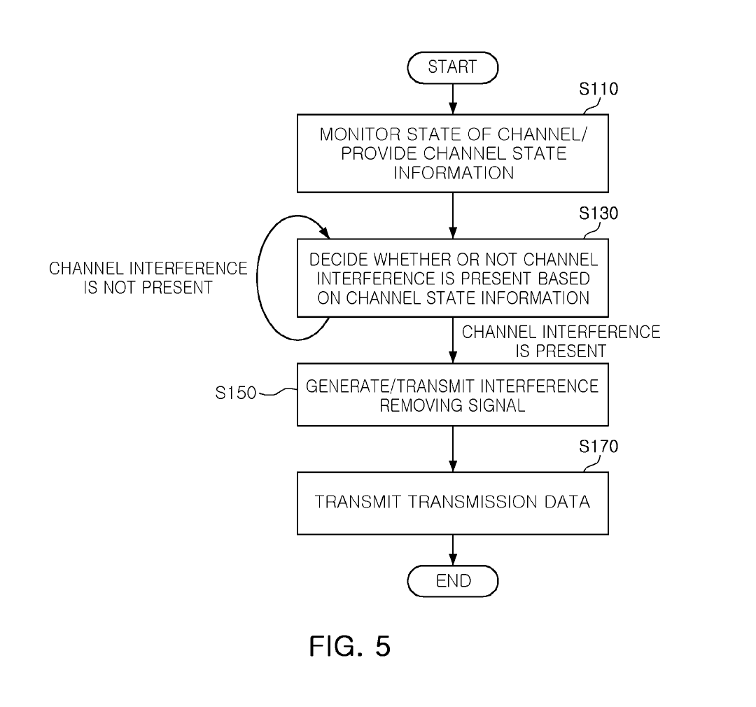

FIG. 4 is a flow chart of a wireless communications method according to an exemplary embodiment in the present disclosure; and FIG. 5 is a flow chart of a wireless communications method according to another exemplary embodiment in the present disclosure.

A wireless communications method according to exemplary embodiments in the present disclosure will be described with reference to FIGS. 4 and 5.

Hereinafter, a description provided with reference to FIGS. 1 through 3 may be applied in describing the wireless communications method according to exemplary embodiments in the present disclosure. Therefore, an overlapped detailed description will be omitted in describing the wireless communications method according to exemplary embodiments in the present disclosure, if possible.

Referring to FIG. 4, first, in an operation (S130), the controlling unit 120 of the wireless communicating apparatus may decide whether or not channel interference is present based on the channel state information on the communications channel according to the first communications standard.

Next, in an operation (S150), the interference removing signal generating unit 130 of the wireless communications apparatus may generate the interference removing signal and transmit the interference removing signal to at least one of the plurality of channels adjacent to the communications channel, when channel interference is present.

Referring to FIG. 5, the wireless communications method according to another exemplary embodiment in the present disclosure may further include an operation (S110) and an operation (S170) in addition to the operations of the wireless communications method according to an exemplary embodiment in the present disclosure shown in FIG. 4.

In the operation (S110), the state of the communications channel may be monitored to provide the channel state information.

Next, in the operation (S170), channel interference may be monitored after the transmitting of the interference removing signal, and the transmission data may be transmitted when channel interference disappears.

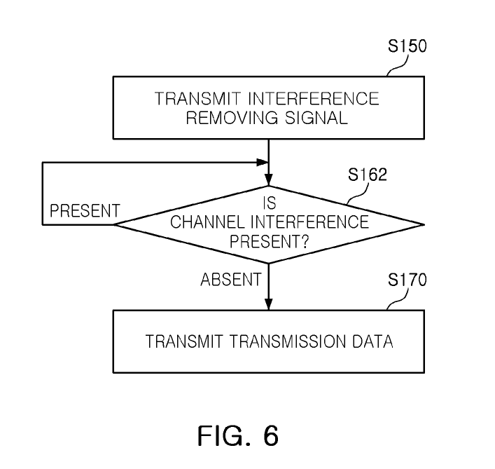

FIG. 6 is a flow chart illustrating an operation of deciding whether or not channel interference is present according to an exemplary embodiment in the present disclosure. Referring to FIG. 6, an operation (S162) of deciding whether or not channel interference is present according to an exemplary embodiment in the present disclosure may be performed between the operation (S150) of transmitting the interference removing signal and the operation (S170) of transmitting the transmission data.

In the operation (S162) of deciding whether or not channel interference is present, it may be decided whether or not channel interference is present in the case in which channel interference is present, and the operation (S170) of transmitting the transmission data may be performed in the case in which channel interference is not present.

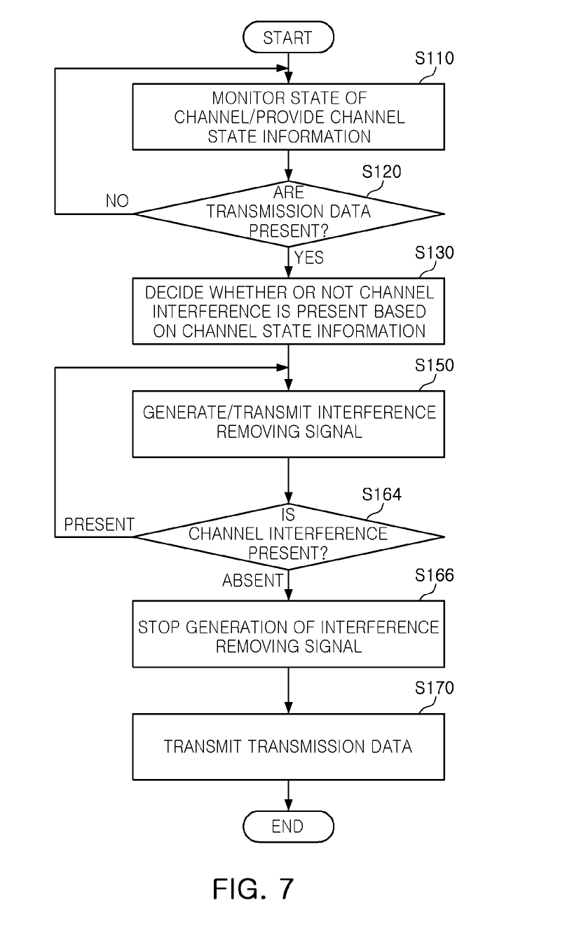

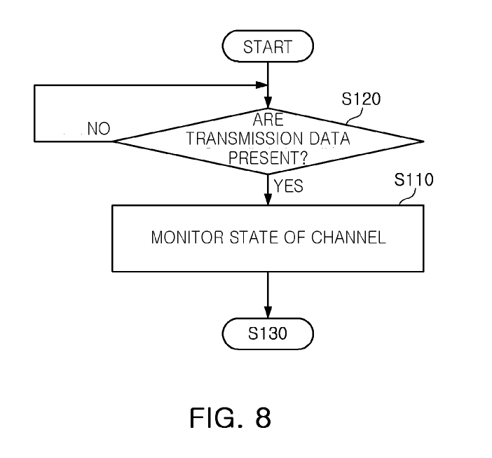

FIG. 7 is a flow chart of a wireless communications method according to another exemplary embodiment in the present disclosure; and FIG. 8 is a flow chart illustrating a process of deciding whether or not channel transmission data are present according to an exemplary embodiment in the present disclosure.

A wireless communications method according to another exemplary embodiment in the present disclosure will be described with reference to FIGS. 7 and 8.

Hereinafter, a description provided with reference to FIGS. 1 through 6 may be applied in describing the wireless communications method according to another exemplary embodiment in the present disclosure. Therefore, an overlapped detailed description will be omitted in describing the wireless communications method according to another exemplary embodiment in the present disclosure, if possible.

Referring to FIG. 7, in an operation (S120), it may be decided whether or not the transmission data are generated. In an operation (S130), it may be decided whether or not channel interference is present based on the channel state information on the communications channel at the time of generation of the transmission data.

In an operation (S150), the interference removing signal may be generated and may be transmitted to at least one of the plurality of channels adjacent to the communications channel, when channel interference is present.

In an operation (S164), it may be decided whether or not channel interference is present after the interference removing signal is transmitted to proceed to the operation of transmitting the interference removing signal when channel interference is present.

In an operation (S166), the generation of the interference removing signal may be stopped when channel interference disappears. Then, in an operation (S170), the transmission data may be transmitted.

The wireless communications method according to another exemplary embodiment in the present disclosure may further include an operation (S110). In the operation (S110), the state of the communications channel may be monitored, and the channel state information may be provided.

The interference removing signal may have signal strength that becomes channel interference in a communications network according to a second communications standard causing interference in the communications channel.

Referring to FIG. 8, the operation (S120) may be performed before the operation (S110), unlike an example shown in FIG. 7. In this case, when the transmission data are present, a process of monitoring the channel state may be performed.

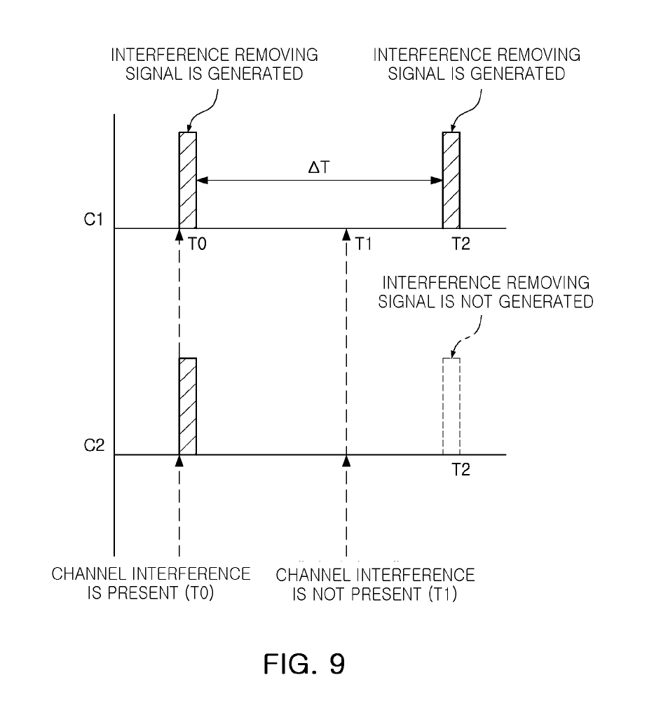

FIG. 9 is a view for describing an example of generation of an interference removing signal according to an exemplary embodiment in the present disclosure.

Referring to FIG. 9, the interference removing signal generating unit 130 may primarily generate and transmit the interference removing signal at a point in time at which channel interference is present (for example, a point in time T0). Then, it is shown that the interference removing signal generating unit 130 may continuously generate and transmit the interference removing signal at a predetermined time interval ΔT in the case in which channel interference disappears and is not present (for example, a point in time T1) in a first case C1. Alternatively, it is shown that the interference removing signal generating unit 130 does not generate a channel interference removing signal any longer in the case in which the channel interference disappears and is not present in a second case C2.

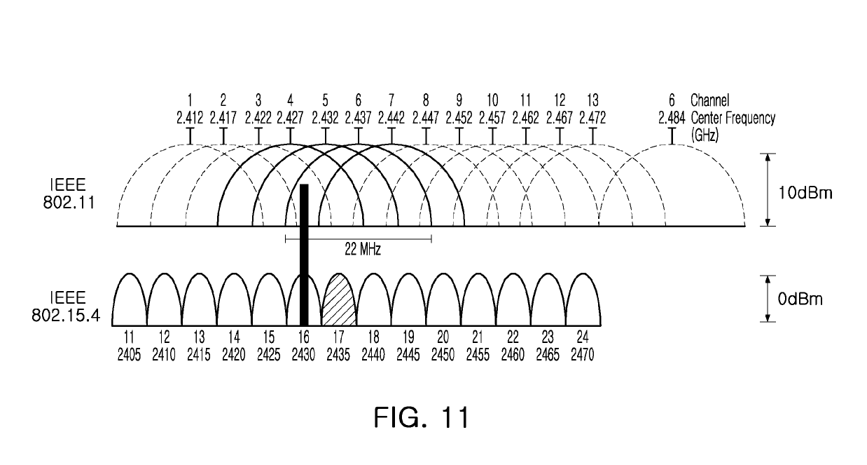

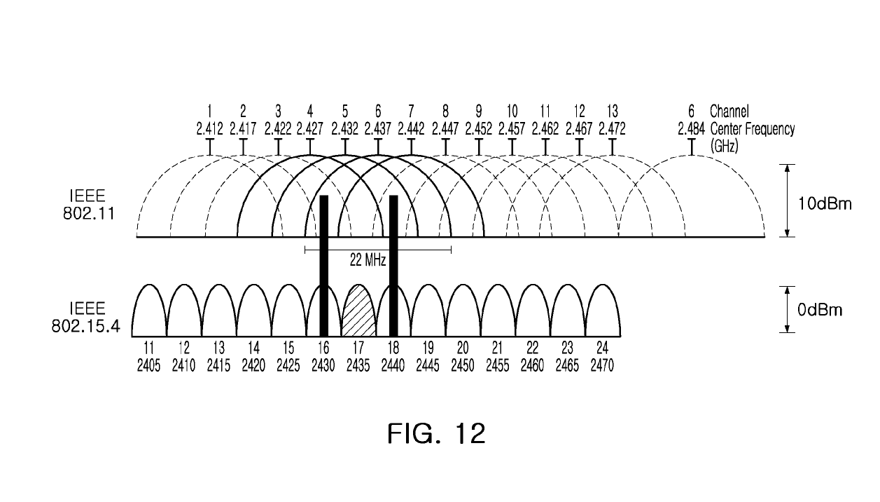

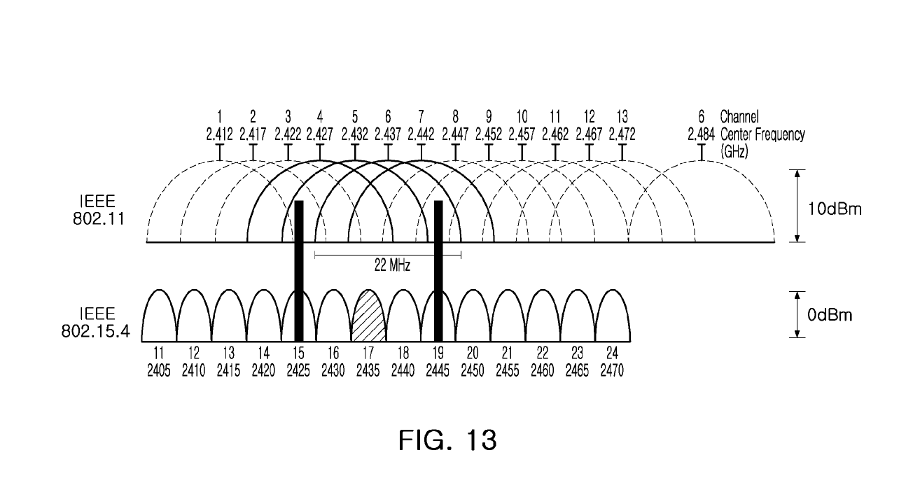

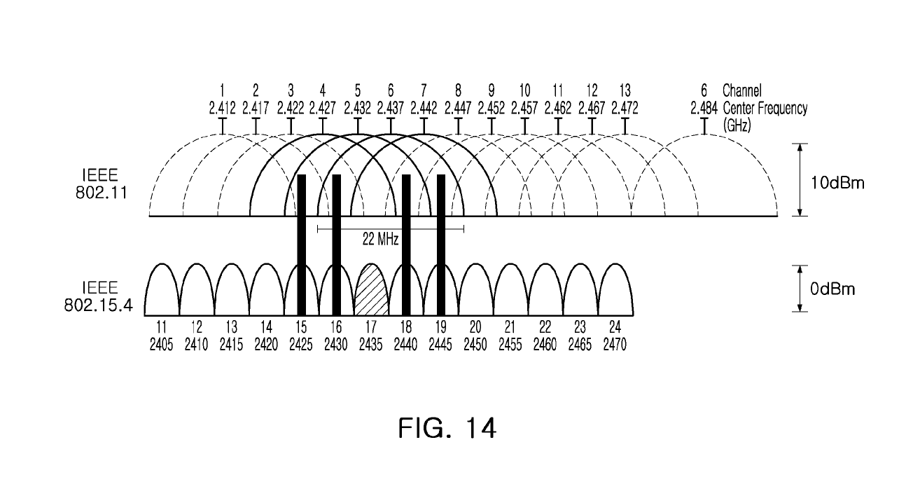

FIG. 10 is a view illustrating an example of a generation band of an interference removing signal according to an exemplary embodiment in the present disclosure; FIG. 11 is a view illustrating another example of a generation band of an interference removing signal according to an exemplary embodiment in the present disclosure; FIG. 12 is a view illustrating another example of a generation band of an interference removing signal according to an exemplary embodiment in the present disclosure; and FIG. 13 is a view illustrating another example of a generation band of an interference removing signal according to an exemplary embodiment in the present disclosure. In addition, FIG. 14 is a view illustrating another example of a generation band of an interference removing signal according to an exemplary embodiment in the present disclosure.

In FIG. 10, an example in which the interference removing signal generating unit 130 transmits the interference removing signal to an upwardly-adjacent channel of the adjacent channels of the communications channel is shown. For example, in the case in which the communications channel is the channel No. 17 (2435 MHz) of the IEEE 802.15.4 communications standard, the interference removing signal may be transmitted to the channel No. 18 (2440 MHz), an upwardly-adjacent channel of the communications channel. In this case, in a channel No. 5 (2432 MHz) to a channel No. 8 (2447 MHz) of the IEEE 802.11 communications standard, the interference removing signal may become a signal causing interference.

In FIG. 11, an example in which the interference removing signal generating unit 130 transmits the interference removing signal to a downwardly-adjacent channel of the adjacent channels of the communications channel is shown. For example, in the case in which the communications channel is the channel No. 17 (2435 MHz) of the IEEE 802.15.4 communications standard, the interference removing signal may be transmitted to the channel No. 16 (2430 MHz), a downwardly-adjacent channel of the communications channel. In this case, in a channel No. 3 (2422 MHz) to a channel No. 6 (2437 MHz) of the IEEE 802.11 communications standard, the interference removing signal may be a signal causing interference.

In FIG. 12, an example in which the interference removing signal generating unit 130 transmits the interference removing signal to lower and upwardly-adjacent channels that are the closest to the communications channel among the adjacent channels of the communications channel is shown. For example, in the case in which the communications channel is the channel No. 17 (2435 MHz) of the IEEE 802.15.4 communications standard, the interference removing signal may be transmitted to the channel No. 16 (2430 MHz) and the channel No. 18 (2440 MHz), which are lower and upwardly-adjacent channels that are the closest to the channel No. 17. In this case, in a channel No. 3 (2422 MHz) to a channel No. 8 (2447 MHz) of the IEEE 802.11 communications standard, the interference removing signal may become a signal causing interference.

In FIG. 13, an example in which the interference removing signal generating unit 130 transmits the interference removing signal to lower and upwardly-adjacent channels that are the second closest to the communications channel among the adjacent channels of the communications channel is shown. For example, in the case in which the communications channel is the channel No. 17 (2435 MHz) of the IEEE 802.15.4 communications standard, the interference removing signal may be transmitted to the channel No. 15 (2425 MHz) and the channel No. 19 (2445 MHz), which are lower and upwardly-adjacent channels that are the second closest to the channel No. 17. In this case, in a channel No. 2 (2417 MHz) to a channel No. 9 (2452 MHz) of the IEEE 802.11 communications standard, the interference removing signal may become a signal causing interference.

Further, in FIG. 14, an example in which the interference removing signal generating unit 130 transmits the interference removing signal to the lower and upwardly-adjacent channels that are the second closest to the communications channel as well as the lower and upwardly-adjacent channels that are the closest to the communications channel among the adjacent channels of the communications channel is shown. For example, in the case in which the communications channel is the channel No. 17 (2435 MHz) of the IEEE 802.15.4 communications standard, the interference removing signal may be transmitted to the channel No. 16 (2430 MHz) and the channel No. 18 (2440 MHz), which are the lower and upwardly-adjacent channels that are the closest to the channel No. 17, and the channel No. 15 (2425 MHz) and the channel No. 19 (2445 MHz), which are the lower and upwardly-adjacent channels that are the second closest to the channel No. 17. In this case, in a channel No. 2 (2417 MHz) to a channel No. 9 (2452 MHz) of the IEEE 802.11 communications standard, the interference removing signal may become a signal causing interference more securely as compared with the case of FIG. 13.

The interference removing signal generating unit 130 described above is not limited to transmitting the interference removing signal as shown in FIGS. 10 through 14, but may transmit the interference removing signal to a plurality of channels adjacent to the communications channel.

The wireless communications apparatus and method according to an exemplary embodiment in the present disclosure as described above may be applied to the repeater of the electronic shelf label system according to the IEEE 802.15.4 communications standard.

In this case, the repeater according to the IEEE 802.15.4 communications standard may exclude interference with the WiFi communications network according to the IEEE 802.11 communications standard, such that the repeater may smoothly perform wireless communications with the plurality of electronic tags without channel interference with the WiFi communications network.

As set forth above, according to exemplary embodiments in the present disclosure, interference between heterogeneous communications networks such as a communications network of the electronic shelf label system, other communications networks, and the like, may be decreased to decrease a standby time for wireless communications, whereby the wireless communications may be more smoothly performed.

As an application, a wireless communications apparatus according to the IEEE 802.15.4 communications standard may exclude interference from a signal according to the IEEE 802.11 communications standard. Therefore, the wireless communications apparatus according to the IEEE 802.15.4 communications standard may smoothly perform the wireless communications without interference.

While exemplary embodiments have been shown and described above, it will be apparent to those skilled in the art that modifications and variations could be made without departing from the scope of the present invention as defined by the appended claims.

What is claimed is:

1. A wireless communications apparatus comprising:
a channel monitoring unit monitoring a state of a communications channel according to a first communications standard and providing channel state information;
a controlling unit deciding whether or not channel interference is present based on the channel state information; and
an interference removing signal generating unit transmitting an interference removing signal to at least one of a plurality of channels adjacent to the communications channel when channel interference is present.

2. The wireless communications apparatus of claim 1, wherein the interference removing signal has signal strength that becomes channel interference in a communications network according to a second communications standard causing interference in the communications channel.

3. The wireless communications apparatus of claim 1, further comprising a wireless communicating unit wirelessly transmitting transmission data when channel interference disappears after the interference removing signal is transmitted.

4. The wireless communications apparatus of claim 1, wherein the interference removing signal generating unit transmits the interference removing signal to at least one lower channel and at least one upper channel of the plurality of channels adjacent to the communications channel.

5. A wireless communications apparatus comprising:
a channel monitoring unit monitoring a state of a communications channel according to a first communications standard and providing channel state information;
a controlling unit deciding whether or not channel interference is present based on the channel state information at the time of generation of transmission data and controlling generation of an interference removing signal when channel interference is present;
an interference removing signal generating unit generating the interference removing signal depending on a control of the controlling unit and repeatedly transmitting the interference removing signal to at least one of a plurality of channels adjacent to the communications channel; and
a wireless communicating unit transmitting the transmission data after the interference removing signal is transmitted,
wherein the channel monitoring unit performs monitoring of the adjacent channels using the wireless communicating unit.

6. The wireless communications apparatus of claim 5, wherein the interference removing signal has signal strength that becomes channel interference in a communications network according to a second communications standard causing interference in the communications channel.

7. The wireless communications apparatus of claim 5, wherein the controlling unit controls the transmission of the transmission data when channel interference disappears during a period in which the interference removing signal is repeatedly transmitted.

8. The wireless communications apparatus of claim 5, wherein the interference removing signal generating unit transmits the interference removing signal to at least one lower channel and at least one upper channel of the plurality of channels adjacent to the communications channel.

9. A wireless communications method comprising:
deciding whether or not channel interference is present based on channel state information on a communications channel according to a first communications standard; and
generating an interference removing signal and transmitting the interference removing signal to at least one of a plurality of channels adjacent to the communications channel, when channel interference is present.

10. The wireless communications method of claim 9, further comprising monitoring a state of the communications channel and providing the channel state information.

11. The wireless communications method of claim 9, further comprising transmitting transmission data when channel interference disappears after the interference removing signal is transmitted.

12. The wireless communications method of claim 9, wherein the interference removing signal has signal strength that becomes channel interference in a communications network according to a second communications standard causing interference in the communications channel.

13. The wireless communications method of claim 9, wherein in the transmitting of the interference removing signal, the interference removing signal is transmitted to at least one lower channel and at least one upper channel of the plurality of adjacent channels of the communications channel.

14. A wireless communications method comprising:
deciding whether or not transmission data are generated;
deciding whether or not channel interference is present based on channel state information on a communications channel at the time of the generation of the transmission data;
generating an interference removing signal and transmitting the interference removing signal to at least one of a plurality of channels adjacent to the communications channel, when channel interference is present;
deciding whether or not channel interference is present after the transmission of the interference removing signal to proceed the transmitting of the interference removing signal when channel interference disappears;
stopping the generation of the interference removing signal when channel interference is not present; and
transmitting the transmission data.

15. The wireless communications method of claim 14, further comprising monitoring a state of the communications channel and providing the channel state information.

16. The wireless communications method of claim 14, wherein the interference removing signal has signal strength that becomes channel interference in a communications network according to a second communications standard causing interference in the communications channel.

17. The wireless communications method of claim 14, wherein in the transmitting of the interference removing signal, the interference removing signal is transmitted to at least one lower channel and at least one upper channel of the plurality of channels adjacent to the communications channel.

18. A wireless communications apparatus comprising:
a channel monitoring unit monitoring a state of a communications channel according to the IEEE 802.15.4 communications standard and providing channel state information;
a controlling unit deciding whether or not channel interference is present based on the channel state information at the time of generation of transmission data and controlling generation of an interference removing signal when channel interference is present;
an interference removing signal generating unit generating the interference removing signal depending on a control of the controlling unit and repeatedly transmitting the interference removing signal to at least one of a plurality of channels adjacent to the communications channel, the interference removing signal having signal strength that becomes channel interference in a communications network according to the IEEE 802.11 communications standard causing interference in the communications channel; and
a wireless communicating unit transmitting the transmission data after the interference removing signal is transmitted,
wherein the controlling unit decides whether or not channel interference is present after the interference removing signal is transmitted and controls the transmission of the transmission data when channel interference disappears.

19. The wireless communications apparatus of claim 18, wherein the interference removing signal has signal strength that is substantially the same as signal strength according to the IEEE 802.11 communications standard.

20. The wireless communications apparatus of claim 18, wherein the interference removing signal generating unit transmits the interference removing signal to at least one lower channel and at least one upper channel of the plurality of channels adjacent to the communications channel.
